(19) United States
(12) Patent Application Publication
(10) Pub. No.: US 2018/0060088 A1
(43) Pub. Date: Mar. 1, 2018

(54) Group Interactions

(71) Applicant: Microsoft Technology Licensing, LLC, Redmond, WA (US)

(72) Inventors: Matthias Baer, Seattle, WA (US); Alice Jane Bernheim Brush, Bellevue, WA (US); Terri Lynne Chudzik, Seattle, WA (US); Peter G. Davis, Kirkland, WA (US); Abolade Gbadegesin, Sammamish, WA (US); Jason Christopher Mayans, Snohomish, WA (US); Naveen K. Yajaman, Redmond, WA (US)

(73) Assignee: Microsoft Technology Licensing, LLC, Redmond, WA (US)

(21) Appl. No.: 15/430,104

(22) Filed: Feb. 10, 2017

Related U.S. Application Data
(60) Provisional application No. 62/382,130, filed on Aug. 31, 2016.
(60) Provisional application No. 62/382,142, filed on Aug. 31, 2016.

(51) Int. Cl. G06F 9/44; G06F 3/16; H04L 29/06

(52) U.S. Cl. CPC G06F 9/4443; H04L 65/403; G06F 3/167

(57) ABSTRACT

Techniques for group interactions are described. In at least some implementations, content associated with a group identity is presented based on priority settings for each user from a group of users. According to various implementations, priority settings are determined for each user based on an individual identity for each user and the group identity. Thus, a group of users can interact with content optimized for priority settings of the group associated with the group identity in a single location.

### RELATED APPLICATIONS

This application claims priority under 35 U.S.C. Section 119(e) to U.S. Provisional Application Ser. No. 62/382130 entitled “Welcome Screen,” and to U.S. Provisional Application Ser. No. 62/382142 entitled “Shared Group Desktop,” both of which were filed on Aug. 31, 2016, the disclosures of which are incorporated by reference herein in their entirety.

### BACKGROUND

Today's connected environment enables individuals to interact in a variety of different ways. Traditional computing devices are associated with an individual identity which can frustrate users that desire a group computing experience. Additionally, traditional computing devices present information in a manner that often requires time before the information is understood by a user. Hence, traditional computing devices can present information in ways that make it difficult for a user to access and/or view.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for group interactions are described. In at least some implementations, content associated with a group identity is presented based on priority settings for each user from a group of users. According to various implementations, priority settings are determined for each user based on an individual identity for each user and the group identity. Thus, a group of users can interact with content optimized for priority settings of the group associated with the group identity in a single location.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Identical numerals followed by different letters in a reference number may refer to different instances of a particular item.

FIG. 1 is an illustration of an environment in an example implementation that is operable to employ techniques discussed herein.

FIG. 2 depicts an example implementation scenario for presenting content associated with a group identity in accordance with one or more embodiments.

FIG. 3 depicts an example implementation scenario for determining priority settings in accordance with one or more embodiments.

FIG. 4 depicts an example implementation scenario for presenting content in accordance with one or more embodiments.

FIG. 5 depicts an example implementation scenario for presenting content in accordance with one or more embodiments.

FIG. 6 depicts an example implementation scenario for group interactions in accordance with one or more embodiments.

FIG. 7 depicts an example implementation scenario for a shared desktop in accordance with one or more embodiments.

FIG. 8 is a flow diagram that describes steps in a method for presenting content associated with a group identity in accordance with one or more embodiments.

FIG. 9 is a flow diagram that describes steps in a method for presenting content associated with a group identity in accordance with one or more embodiments.

FIG. 10 is a flow diagram that describes steps in a method for presenting content to a group in accordance with one or more embodiments.

FIG. 11 illustrates an example system and computing device as described with reference to FIG. 1, which are configured to implement embodiments of techniques described herein.

### DETAILED DESCRIPTION

### Overview

Techniques for group interactions are described. In at least some implementations, content associated with a group identity is presented based on priority settings for each user from a group of users. According to various implementations, priority settings are determined for each user based on an individual identity for each user and the group identity. Thus, a group of users can interact with content optimized for priority settings of the group associated with the group identity in a single location.

According to various implementations, a group platform module can be leveraged to perform content aggregation and/or presentation for a group of individuals. The group platform module, for instance, can manage, control, and/or interact with an operating system of a client device to enable the group interaction techniques described herein. Further, the group platform module maintains group platform policies that specify permissions and criteria for aggregating and/or presenting content for a group of individuals.

According to various implementations, the group platform module can generate a shared desktop in which the group of individuals can interact. Further, a graphical user interface (GUI) can be output by the group platform module to enable a group of individuals to organize, coordinate, share, and present information. The GUI represents a location to promote quick and easy interaction with displayed content.

According to various implementations, a group identity is identified for a group. Further, an individual identity for each individual user from the group is identified. The group platform module determines priority settings for each user based on the individual identity for each user and the group identity. Content is presented to enable one or more users associated with the group identity to interact with the presented content. For instance, the group platform module causes the content to be presented on an interface of a client device, the content optimized for the priority settings. This permits the one or more users associated with the group identity to interact with the presented content through the GUI optimized for group interactions.

Generally, techniques described herein conserve various device resources, such as by reducing a number of user interactions required to present content tailored to individual user and group identities. By reducing user interactions, device resources such as processor and memory resources are conserved.

In the following discussion, an example environment is first described that is operable to employ techniques described herein. Next, some example implementation scenarios are presented in accordance with one or more implementations. Following this, some example procedures are discussed in accordance with one or more implementations. Finally, an example system and device that are operable to employ techniques discussed herein in accordance with one or implementations is described.

### Example Environment

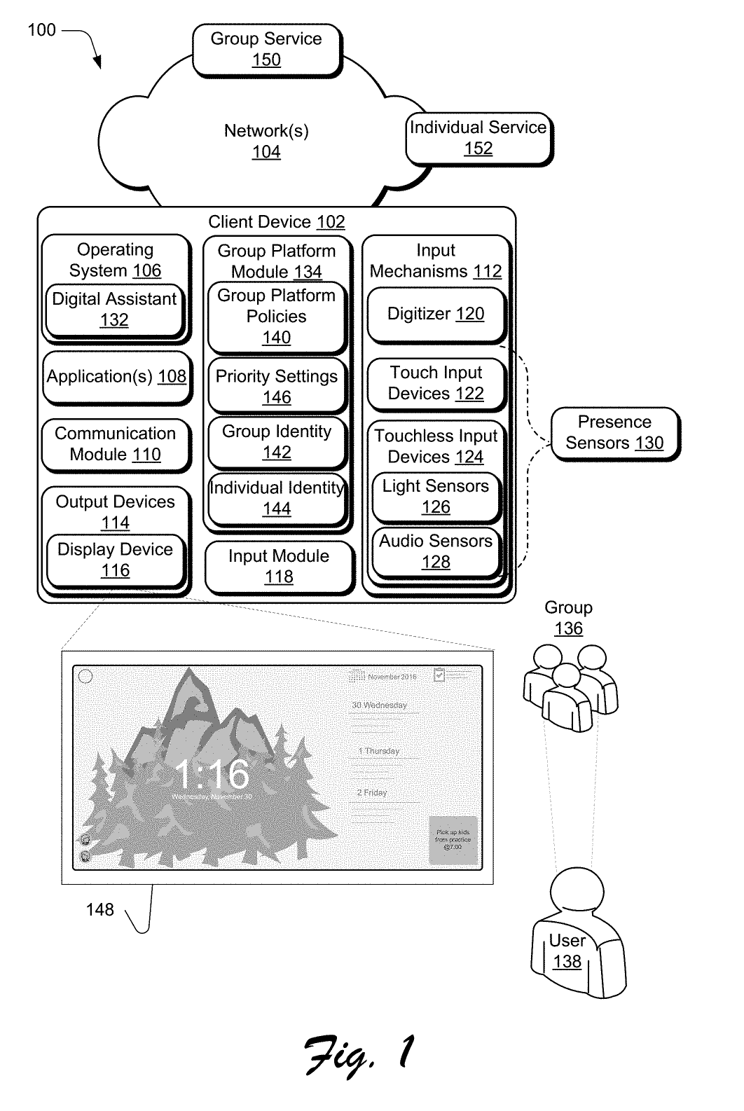

FIG. 1 is an illustration of an environment 100 in an example implementation that is operable to employ techniques for group interactions discussed herein. Generally, the environment 100 includes various devices, services, and networks that enable interaction via a variety of different modalities. For instance, the environment 100 includes a client device 102 connected to a network 104. The client device 102 may be configured in a variety of ways, such as a traditional computer (e.g., a desktop personal computer, laptop computer, and so on), a mobile station, an entertainment appliance, a smartphone, a wearable device, a netbook, a game console, a handheld device (e.g., a tablet), and so forth. According to various implementations, the client device 102 may be configured for output without a screen, such as audio output, haptic output, and so forth.

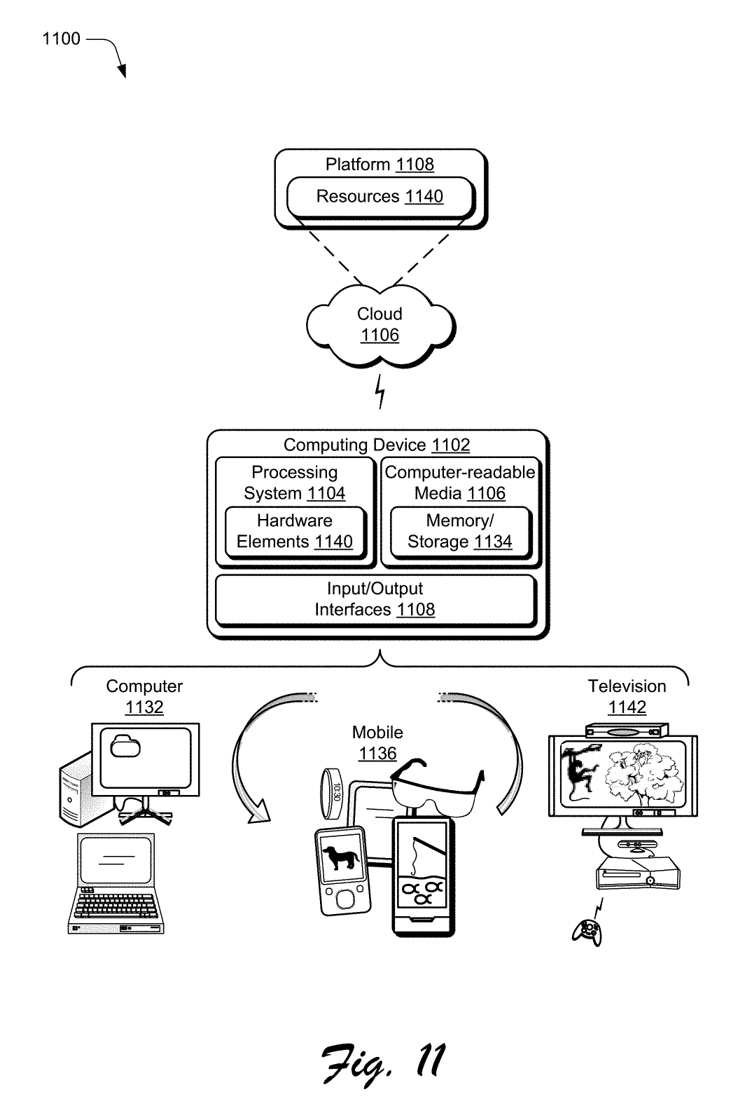

In at least some implementations, the client device 102 represents a smart appliance, such as an Internet of Things (“IoT”) device. Thus, the client device 102 may range from a system with significant processing power, to a lightweight device with minimal processing power. One of a variety of different examples of the client device 102 is shown and described below in FIG. 11.

The network 104 is representative of a network that provides the client device 102 with connectivity to various networks and/or services, such as the Internet. The network 104 may provide the client device 102 with connectivity via a variety of different connectivity technologies, such as broadband cable, digital subscriber line (DSL), wireless cellular, wireless data connectivity (e.g., WiFi™), T-carrier (e.g., T1), Ethernet, and so forth. In at least some implementations, the network 104 represents different interconnected wired and wireless networks. The network 104 may be implemented in various ways, such as a local access network (LAN), a wide area network (WAN), the Internet, and so forth.

The client device 102 includes a variety of different functionalities that enable various activities and tasks to be performed. For instance, the client device 102 includes an operating system 106, applications 108, and a communication module 110. Generally, the operating system 106 is representative of functionality for abstracting various system components of the client device 102, such as hardware, kernel-level modules and services, and so forth. The operating system 106, for instance, can abstract various components of the client device 102 to the applications 108 to enable interaction between the components and the applications 108.

The applications 108 represent functionalities for performing different tasks via the client device 102. Examples of the applications 108 include a word processing application, a spreadsheet application, a web browser, a gaming application, a media player, and so forth. The applications 108 may be installed locally on the client device 102 to be executed via a local runtime environment, and/or may represent portals to remote functionality, such as cloud-based services, web apps, and so forth. Thus, the applications 108 may take a variety of forms, such as locally-executed code, portals to remotely hosted services, and so forth.

The communication module 110 is representative of functionality for enabling the client device 102 to communicate data over wired and/or wireless connections. For instance, the communication module 110 represents hardware and logic for data communication via a variety of different wired and/or wireless technologies and protocols.

The client device 102 further includes various functionalities for input and output, including input mechanisms 112, output devices 114, and an input module 118. The input mechanisms 112 generally represent different functionalities for receiving input to the client device 102, and the input module 118 is representative of functionality to enable the client device 102 to receive input data from the input mechanisms 112 and to process and route the input data in various ways.

The output devices 114 generally represent different functionalities for output from the client device 102. Examples of the output devices 114 include a display device 116 (e.g., a monitor or projector), speakers, a printer, a tactile-response device, and so forth. The display device 116 represents functionality for visual output for the client device 102. Additionally, the display device 116 represents functionality for receiving various types of input, such as touch input, pen input, and so forth. The display device 116, for example, represents an instance of the input mechanisms 112.

The input mechanisms include a digitizer 120, touch input devices 122, and touchless input devices 124. Examples of the input mechanisms 112 include gesture-sensitive sensors and devices (e.g., such as touch-based sensors and movement-tracking sensors (e.g., camera-based)), a mouse, a keyboard, a stylus, a touch pad, accelerometers, a microphone with accompanying voice recognition software, and so forth. The input mechanisms 112 may be separate or integral with the output devices 114 (e.g., the display device 116); integral examples include gesture-sensitive displays with integrated touch-sensitive or motion-sensitive sensors. The digitizer 120 represents functionality for converting various types of input to the touch input devices 122, touchless input devices 124, and/or the display device 116 into digital data that can be used by the client device 102 in various ways, such as for generating digital ink.

The touch input devices 122 generally represent different devices for recognizing touch input, and are configured to receive touch input in a variety of ways. For example, the touch input devices 122 may include capacitive sensors, gesture-sensitive touch sensors, camera-based sensors or other sensors configured to detect physical touch and/or touch input functionality.

The touchless input devices 124 generally represent different devices for recognizing different types of non-contact input, and are configured to receive a variety of touchless input, such as via visual recognition of human gestures, object scanning, voice recognition, color recognition, recognition of user identity, and so on. For instance, the touchless input devices 124 include light sensors 126, audio sensors 128, and/or any combination thereof. While not expressly illustrated, other types of touchless input devices 124 may be employed, such as to detect orientation, acceleration, rotation, electromagnetic radiation (e.g., radio waves, microwaves, infrared), capacitance, and so forth.

In at least some implementations, the touchless input devices 124 are configured to recognize gestures, poses, body movements, objects, images, and so on, via cameras. An example camera, for instance, can be configured with lenses, light sources, and/or light sensors such that a variety of different phenomena can be observed and captured as input. For example, the camera can be configured to sense movement in a variety of dimensions, such as vertical movement, horizontal movement, and forward and backward movement, e.g., relative to the touchless input devices 124. Thus, in at least some implementations, the touchless input devices 124 can capture information about image composition, movement, and/or position.

According to various implementations, different instances and combinations of the touch input devices 122 and the touchless input devices 124 can be implemented as presence sensors 130. Generally, the presence sensors 130 may sense various phenomena such as user presence, user distance, user identity recognition, biometric attributes, sound (e.g., user speech and other sounds), light (e.g., environmental lighting changes), along with other user and/or environmental attributes. The presence sensors 130 may alternatively or additionally detect other types of contextual information, such as user identity, time of day, user preferences, and so forth.

The presence sensors 130 may detect the physical presence of people (i.e., nearby the client device 102) using sensors like pyro-electric infrared sensors, passive infrared (PIR) sensors, microwave radar, microphones or cameras, and using techniques in accordance with the input module 118 such as

Doppler radar, radar using time-of-flight sensing, angle-of-arrival sensing inferred from one of the above techniques, and so forth. While the inferences from PIR sensors are mostly binary, modalities like radar can provide more fine-grained information, that can include a positioning element (e.g., x/y/z position relative to the PC), an element indicative of distance to the person (e.g., magnitude of the returned signal), or an element that allows for inferences of certain situations like approaching the system. Another technique to recognize presence involves using position of a user's other devices, such as detecting that a user's smartphone or tablet device is connected within a network.

In order to enable voice interaction functionality, one or multiple microphones can be employed. Using multiple microphones enables the use of sophisticated beamforming techniques to raise the quality of speech recognition and thus the overall interaction experience. Also, the system can disambiguate between multiple sound sources (e.g., by filtering out the position of a known TV or background noise). When the identity of a user is known, it is possible to use a different speech recognition model that actually fits the user's accent, language, acoustic speech frequencies, and demographics (e.g., age).

As noted above, radar or camera-based sensors may provide a position for one or multiple users. The position is then used by the input module 118 to infer context. For example, whether a person just passes by or has the intention to actually interact. Distance and/or proximity can also be detected using ultrasonic, time-of-flight, radar, and/or other techniques.

The input module 118 may perform identity recognition by employing camera-based face recognition or more coarse-grained recognition techniques that approximate the identity of a user (e.g. when she or he is further away). The system may also recognize the locations or movements of other devices which may be personal devices, and the input module 118 may use this to determine identity. This may be done with or without cooperating software components on those devices. For example, accelerometer events detected by a smartphone may be correlated with movements sensed for a particular user, allowing the system to infer that, with some probability, the moving user's identity is that of the smartphone owner. In another example, the radio signals (e.g., WiFi signals) from a smartphone may be localized and this location may be correlated to a user to (probabilistically) identify the user.

Similar to the previously discussed camera-based identity recognition, estimating an emotional state is another factor that may be employed. The emotional state can be derived based on the presence sensors 130 to infer a situation in which an emotional state of a user that can be used to adapt the system behavior even further. Thermographic imaging, biometric sensor data, and voice analysis can also be used to infer emotional state.

The presence sensors 130 may be included with the client device 102 and/or available from other connected devices, such as sensors associated with multiple computers in a home network, sensors on a user's phone, sensors integrated in a display device, and so forth. A presence sensor 130 and/or set of the presence sensors 130, for instance, can be implemented as a dedicated sensor subsystem with a dedicated processor, storage, power supply, and so forth, that can detect various phenomena and communicate signals to the client device 102, such as a binary signal to wake the client device 102 from a sleep or off mode. The presence sensors 130, for instance, can actively detect various phenomena and contextual information while the client device 102 is in a sleep mode. In at least some implementations, the client device 102 may communicate with and obtain sensor data from connected devices over the network 104 and/or via a local or cloud service.

The client device 102 may include or make use of a digital assistant 132. In the illustrated example, the digital assistant 132 is depicted as being integrated with the operating system 106. The digital assistant 132 may additionally or alternatively be implemented as a stand-alone application, a component of a different application, as a network-based service (e.g., a cloud-based service), and so forth.

Generally, the digital assistant 132 is representative of functionality to utilize natural language processing, a knowledge database, and artificial intelligence implemented by the system to interpret and perform requested tasks, provide requested advice and information, and/or invoke various services to complete requested actions. For example, requests received by the digital assistant 132 may include spoken or written (e.g., typed text) data that is received through the input module 118 via the input mechanisms 112 and interpreted through natural language processing capabilities of the digital assistant 132. The digital assistant 132 may interpret various input and contextual clues to infer an intent, translate the inferred intent into actionable tasks and parameters, and then execute operations and deploy services to perform the tasks. Thus, the digital assistant 132 is designed to act on behalf of a user to produce outputs that fulfill the user's intent as expressed during natural language interactions between the user and the digital assistant.

The client device 102 further includes a group platform module 134, which is representative of functionality to perform various tasks pertaining to techniques for group interactions discussed herein. The group platform module 134, for instance, can be leveraged to manage interactions for a group 136 and a user 138. For example, the group platform module 134 perform content aggregation and/or presentation for the group 136 and the user 138. Various attributes and operational aspects of the group platform module 134 are detailed below. In implementations, the group platform module 134 can manage, control, and/or interact with the operating system 106 of the client device 102 to enable the group interaction techniques described herein. As described herein, “a group” can refer to one or more individuals. In some instances, a group is representative of a family, a group of friends, roommates, co-workers, a caregiver, a guest, and so on. As such, the term “a group” as used herein generally represents one or more individuals referred to collectively.

The group platform module 134 maintains group platform policies 140, which are representative of different sets of data that specify permissions and criteria for aggregating and/or presenting content for the group 136. The group platform policies 140, for instance, specify which content to present and how to configure content for display based on factors associated with priority, identity, presence of individuals, and so forth. Alternatively or additionally, the group platform policies 140 are content and/or application-specific. For example, the group platform policies 140 can specify certain types of content that are permitted to be presented to each member of the group 136, and other types of content that are not permitted to be presented to each member of the group 136. Generally, the group platform policies 140 can be configured in various ways such as via default settings, settings specified by an end user, by information technology (IT) personnel, by application development personnel, and so forth.

The group platform module 134 may include or make use of a group identity 142 and an individual identity 144. Generally, the group identity 142 corresponds to a device ticket, a credential, or other qualification that is suitable for representing the group 136 of one or more individual users, enabling each individual in the group 136 to interact with a computing device using the group identity 142.

Each individual in the group 136 can be represented by a unique individual identity 144 which may be used to identify and authenticate the individual. Generally, the individual identity 144 corresponds to a device ticket, a user ticket, a credential, or other qualification that is suitable for representing an individual user.

Generally, the group platform module 134 can create and/or modify the group platform policies 140 related to the group identity 142 including but not limited to settings for an account profile, email accounts for the group 136 and/or email accounts for users associated with the group 136, Virtual Private Network (VPN) access, sign-in options (e.g., use of biometrics and other specific sensors for identifying a user), device location tracking settings, privacy settings, recovery settings, back-up settings, and so on. Further, privacy settings provided by the group platform policies 140 can include settings related to account information, application information, messaging, and/or email, just to name a few. Privacy settings can be provided by default by the group platform module 134 or the operating system 106, for instance, or may be provided by a user from the group 136. Settings can also be provided to specify access for a guest to content associated with the group identity 142 by the group platform policies 140. In some implementations, a caregiver, relative, and/or friend can be added to the group identity 142 to provide interactions with the group 136 associated with the group identity 142. According to various implementations, the group platform policies 140 may also allow public access to content associated with the group identity 142 to a user detected in proximity, even if the user is not specifically identified as part of the group identity 142.

According to various implementations, the group platform module 134 can enable each individual associated with the group 136 to interact with the client device 102 using the same group identity 142. For instance, the group platform module 134 can use the group identity 142 to automatically authorize interactions for each group member, typically after one group member initiates creating the group 136. In one specific example, the group platform module 134 can automatically authorize access for each individual associated with the group identity 142 to functionality provided by the group platform module 134. In this way, each individual of the group 136 can automatically interact with the functionality provided by the group platform module 134 independent of being required to provide an express input.

The group platform module 134 further maintains priority settings 146, which are representative of different sets of data that specify priority for each individual user from the group 136 relative to each other. The priority settings 146 may be determined by the group platform module 134 for each user from the group 136 and may be based on the group identity 142 and the respective individual identity 144 of each user. In various implementations, the priority settings 146 may be content and/or application-specific and may be used by the group platform module 134 to resolve conflicts regarding presentation of content. Generally, the priority settings 146 may be based on user-defined or default settings and may be originally assigned in a number of ways including assignment upon initial creation of the group identity 142. Further to techniques discussed herein, the priority settings 146 are determined and enforced in accordance with the group platform policies 140 and, as a result, modification of the group platform policies 140 may cause modification to the priority settings 146.

According to various implementations, the group platform module 134 may operate under the influence of sensor data collected via the presence sensors 130 to perform various tasks, such as to manage and adapt device modes, availability of the digital assistant 132, application states, and so forth. The adaptations implemented via the group platform module 134 include selectively invoking, waking, and suspending the digital assistant 132 in dependence upon indications obtained from the presence sensors 130 and/or the input module 118, such as user presence, identity, and/or proximity. The adaptations further include selective modification to a user experience (“UX”) based on sensor data and context.

In at least some implementations, the group platform module 134 can generate a desktop in which individuals from the group 136 can interact. As described herein, a “desktop” represents an interaction point for persons operating a computing device, such as the client device 102, in accordance with the group identity 142. A desktop, for instance, represents a functional collection of interaction affordances that can be configured in various ways according to techniques for group interactions described herein. A desktop, for instance, can include visual aspects, audible aspects, tactile aspects, and/or combinations thereof. Because a desktop generated by the group platform module 134 operates in the context of the group identity 142, the desktop can be thought of as a “communal desktop” or a “shared desktop.” Generally, a shared desktop generated by the group platform module 134 can be useful in settings where people congregate because it promotes sharing without the hindrances found in typical group interfaces.

According to various implementations, the group platform module 134 provides a shared desktop that operates with functionality of the operating system 106. For instance, the shared desktop can be generated by the group platform module 134 to incorporate a system shell (start button, taskbar, action center, etc.) that provides a desktop having a group context. The shared desktop can integrate data from various sources to provide applications and/or services in accordance with the group context. In some instances, individuals of the group 136 control their individual data by “pushing” their respective data to the shared desktop. Thus, in some implementations, the group platform module 134 can be configured to let individuals control their privacy (e.g., personal data). In this way, the group platform module 134 can form the shared desktop to include sub-sets of individual data which do not include sensitive individual data that a particular individual would rather not include in the group context.

The environment 100 further includes an example snapshot of a graphical user interface (“GUI”) 148 that can be output on the output devices 114 (e.g., the display device 116) by the group platform module 134 to employ group interaction techniques. By configuring the GUI 148 in the various ways described herein, the group platform module 134 can employ group interaction techniques that enable a group of individuals to organize, coordinate, share, and present information. According to various implementations, the GUI 148 can be implemented by the group platform module 134 as an application and/or a UX and can be made available to devices associated with the group identity 142 via the network 104 or locally. Regardless of where the GUI 148 is used, the GUI 148 is generally representative of a location to promote quick and easy interaction with displayed content.

The group platform module 134 may configure the GUI 148 for implementation with various adaptations including selectively invoking, waking, and suspending the GUI 148 in dependence upon indications obtained from the presence sensors 130, such as user presence, identity, and/or proximity. The adaptations further include selective modification to the UX based on sensor data and context. For example, different visualizations of the GUI 148 may be output for different interaction scenarios based on user presence. In some implementations, the GUI 148 may be dynamically adapted through the course of a particular action based on recognized changes to number of users present, proximity, availability of secondary device/display, lighting conditions, user activity, and so forth. Further, the GUI 148 may also be adapted based on accessibility considerations, such as to accommodate various disabilities. According to various implementations, the group platform module 134 configures the GUI 148 for implementation with various adaptations including selectively invoking, waking, and suspending the GUI 148 in dependence upon a time of day or learned behavior of the group 136 or an individual from the group 136.

As described above, the group platform module 134 obtains sensor data that may be collected via various presence sensors 130. The sensor data is analyzed and interpreted by the group platform module 134 to determine contextual factors such as user presence, identity, proximity, emotional state, and other factors noted above and below. Adaptations that correspond to a current context are thus identified and applied to adapt the GUI 148 accordingly.

In this environment, the user 138 represents a single user associated with the group 136, but it will be appreciated that more than one user may interact with the GUI 148 in this environment.

The environment 100 further includes a group service 150 and an individual service 152 which are accessible to the client device 102 over the network 104. Generally, the group service 150 is representative of a network-based functionality for providing account, profile, data, and services related to the group identity 142. In at least some implementations, the group identity 142 and/or the individual identity 144 may be obtained from the group service 150.

Techniques for group interactions discussed herein may be performed by the group platform module 134, the group service 150, and/or via interaction between the group platform module 134 and the group service 150. In at least some implementations, the group service 150 hosts an instance of the group platform module 134 that is accessible to the client device 102 and other devices over the network 104, including other devices used by the user 138 from the group 136 or other individuals from the group 136.

The individual service 152 is representative of a network-based functionality for providing account, profile, data, and services related to the individual identity 144 associated with the user 138 from the group 136. For instance, providing account, profile, and services related to the individual identity 144 may be performed by the group platform module 134, the individual service 152, and/or via interaction between the group platform module 134 and the individual service 152. While the group service 150 and the individual service 152 are represented in FIG. 1 as separate elements, it should be appreciated that the functionality of both the group service 150 and the individual service 152 may be performed by a single identity service, the group platform module 134, and/or interactions between an identity service and the group platform module 134.

Having described an example environment in which the techniques described herein may operate, consider now a discussion of some example implementation scenarios in accordance with one or more embodiments.

### Example Implementation Scenarios

The following section describes example implementation scenarios for group interactions in accordance with one or more implementations. The implementation scenarios may be implemented in the environment 100 discussed above, the system of FIG. 11, and/or any other suitable environment.

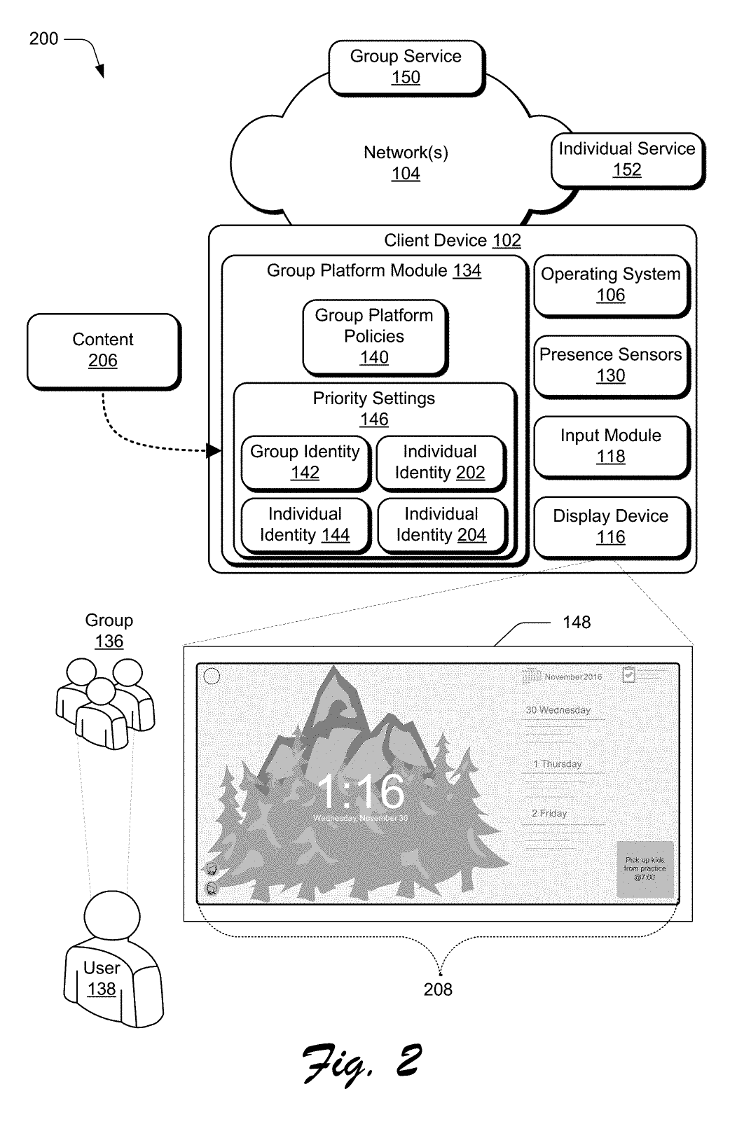

FIG. 2 depicts an example implementation scenario 200 for presenting content associated with a group identity in accordance with one or more implementations. The scenario 200 includes various entities and components introduced above with reference to the environment 100.

The scenario 200 includes the user 138 in the vicinity of the client device 102 having the group platform module 134. Accordingly, the group platform module 134 receives an indication that the user 138 is present and/or in close proximity to the GUI 148. For instance, the indication may be provided by the presence sensors 130, the input module 118, or any combination thereof. The presence sensors 130, for example, detect the presence of the user 138, and an identity of the user 138.

Accordingly, the group platform module 134 identifies the individual identity 144 associated with the user 138. In one implementation, the individual identity 144 was initially assigned by the operating system 106. Different ways of detecting identity, presence, and proximity are detailed above.

As shown, the GUI 148 is presented on the display device 116 to the user 138 for group interactions and represents a single physical location for interacting. In this instance, the user 138 represents a single user associated with the group 136, but it will be appreciated that more than one user may interact with the GUI 148 in this scenario.

The group platform module 134 identifies the group identity 142 that is associated with the group 136 and the user 138. The individual identity 144 associated with the user 138 along with an individual identity 202 and an individual identity 204 for other users from the group 136 are identified as well. The group platform module 134 may obtain the group identity 142 from the group service 150 and/or the individual identities 144, 202, and 204 from the individual service 152 over the network 104. In one implementation, the group identity 142 was initially assigned by the operating system 106, such as during initial setup of the client device 102.

The group identity 142 may be created in several ways including, for example, during an “out-of-the-box experience” upon initial setup of a shared computing device. The shared computing device (which may be the client device 102), for instance, includes the group platform module 134 and the operating system 106 configured to generate the group identity 142 by verifying an individual user's identity upon initial setup of the shared computing device. According to various implementations, the group platform module 134 creates the group identity 142 for each user associated with the group 136 and assigns the group identity 142 automatically to each user associated with the group 136. In some implementations, the group identity 142 is created from a device other than the shared computing device, including but not limited to the client device 102.

According to various implementations, content 206 associated with the group identity 142 is identified and/or aggregated by the group platform module 134. Generally, the group platform module 134 forms, collects, exchanges, and/or aggregates the content 206 related to the group identity 142 and the individual identity 144. In various implementations, the group platform module 134 causes content obtained (e.g., purchased) by an individual user from the group 136 to be stored in association with the group identity 142. In further implementations, the group platform module 134 enables one or more users from group 136 to communicate and/or exchange data through first or third-party applications or services using the group identity 142. Additionally, the group platform module 134 may identify first or third-party applications, services, or data associated with an individual identity of a user from the group 136 and cause conversion in whole or in part of the applications, services or data to a group context in association with the group identity 142.

In order to optimize the content 206 presented to users associated with the group identity 142, the group platform module 134 determines priority settings 146 for presenting the content 206 in accordance with the group platform policies 140. The priority settings 146 are determined for each user from the group 136 relative to each other based on the group identity 142 and the respective individual identities 144, 202, 204 for each user.

The group platform module 134 presents optimized content 208 associated with the group identity 142 and the individual identity 144 on the GUI 148 to enable the user 138 to interact with the optimized content 208. The group platform module 134, for instance, optimizes the content 206 to generate the optimized content 208 based on the individual identity 144 of the user 138 as applied to the priority settings 146 in accordance with the group platform policies 140. As an example, consider that the content 206 aggregated by the group platform module 134 includes both a calendar appointment associated with the individual identity 144 of the user 138 and a calendar appointment associated with the group identity 142 and the individual identity 144. The group platform module determines the priority settings 146 based on the individual identities 144, 202, 204, as well as the group identity 142. Thus, in this example, the priority settings 146 indicate that content associated with the individual identity 202 has priority over content associated with the group identity 142 but not the individual identity 144. Since the user 138 associated with the individual identity 144 is present, for example, the individual identity 144 has a highest priority of the different identities. As a result, the calendar appointment associated with the individual identity 144 is presented on the GUI 148, while the calendar appointment associated with the individual identity 202 is not presented.

In one implementation, the group platform module 134 directs the operating system 106 to operate as the group identity 142. Further, the group platform module 134 causes the optimized content 208 to be further optimized for a presence of individuals other than the user 138 detected to be in the vicinity of the GUI 148 by the presence sensors 130.

In some implementations, the GUI 148 can be output on a display of a device(s) other than the client device 102. Additionally or alternatively, the GUI 148 can be output on a display of a user associated with the group identity 142 other than the user 138. In this instance, the GUI 148 is output on the display device 116, but it will be appreciated that any of the output devices 114 are contemplated to enable the functionality of the GUI 148 of this scenario. 148 148 142 138

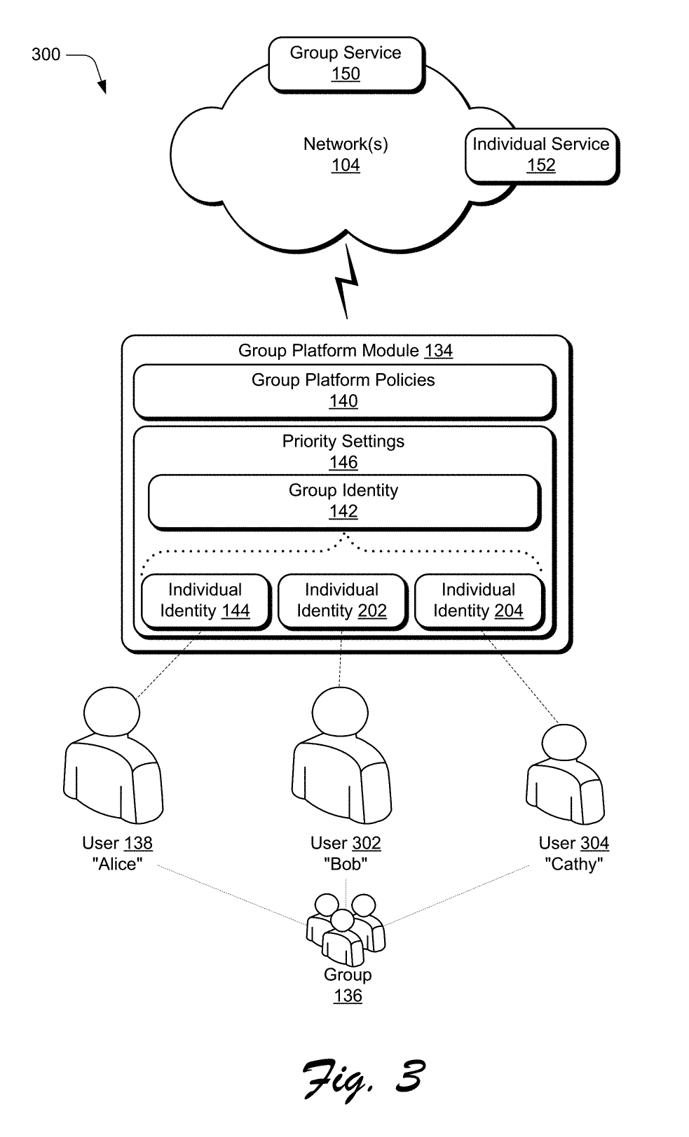

FIG. 3 depicts an example implementation scenario 300 for determining priority settings in accordance with one or more implementations. The scenario 300 includes various entities and components introduced above with reference to the environment 100 and the scenario 200.

The scenario 300 includes the group 136 representative of a group of individual users, the user 138 (an adult, “Alice”), adult user 302 (“Bob”), and child user 304 (“Cathy”) associated with the group 136. In the scenario, the group platform module 134 authorizes the group identity 142 for Alice, Bob, and Cathy, associated with the group 136. In some implementations, the group identity 142 may be authorized from the group service 150.

In this particular scenario, the group platform module 134 communicates over the network 104 with the individual service 152 that provides account, profile, and services related to the individual identities 144, 202, 204 corresponding to Alice, Bob, and Cathy, respectively. However, in other implementations, the individual identities 144, 202, 204 may be authorized from the group service 150 as well. In at least one implementation, the operating system 106 from FIG. 1 may be configured to run as the individual identity 144, 202, or 204 for Alice, Bob, or Cathy respectively.

Further to this scenario, an adult user, Alice (138) sets up the shared computing device for group use to include herself, Bob (adult user 302), and Cathy (child user 304) in group 136. Accordingly, the group platform module 134 automatically associates the group identity 142 with the individual identities 144, 202, 204 associated with Alice, Bob, and Cathy, respectively. In other implementations, the group platform module 134 may associate the group identity 142 with each user associated with the group 136 even if each user is not associated with the shared computing device, and/or across multiple platforms, networks, or applications.

Generally, the group platform module 134 configures the group identity 142 for use in various ways that enable each associated user to efficiently bypass conventional barriers to interacting with content associated with the group identity 142. For example, the group platform module 134 can configure the group identity 142 as a device ticket that communicates security information related to the group 136 to other applications and/or services. Thus, in this scenario, subsequent to Alice setting up the shared desktop, Bob and Cathy may access “group-aware” content free of further input.

Alice, Bob, and Cathy may have different priority settings 146 determined based on the group identity 142 and the individual identities 144, 202, 204. For instance, Alice and Bob (as adult users) and Cathy (as a child user) have different priority settings 146 for interacting with content associated with the group identity 142, in accordance with the group platform policies 140. In various implementations, the priority settings 146 are assigned upon initial creation of the group identity 142. As one example, upon initial setup of the group identity 142, the users associated with the group 136, Alice, Bob, and Cathy, may be identified by age or age classification (i.e., adult and child) by Alice while performing the initial setup. As a result, different priority settings 146 and group platform policies 140 will be determined for Cathy, relative to Alice and Bob, due to Cathy's age and/or age classification, e.g., child, in this example.

Thus, the group platform module 134 causes content presented to be group-aware by modifying the content for output in accordance with the group identity 142 and the priority settings 146. As detailed below, the modifying can include altering, replacing, updating, including, excluding, and/or exchanging data for presentation to meet the collective needs of each user from the group 136.

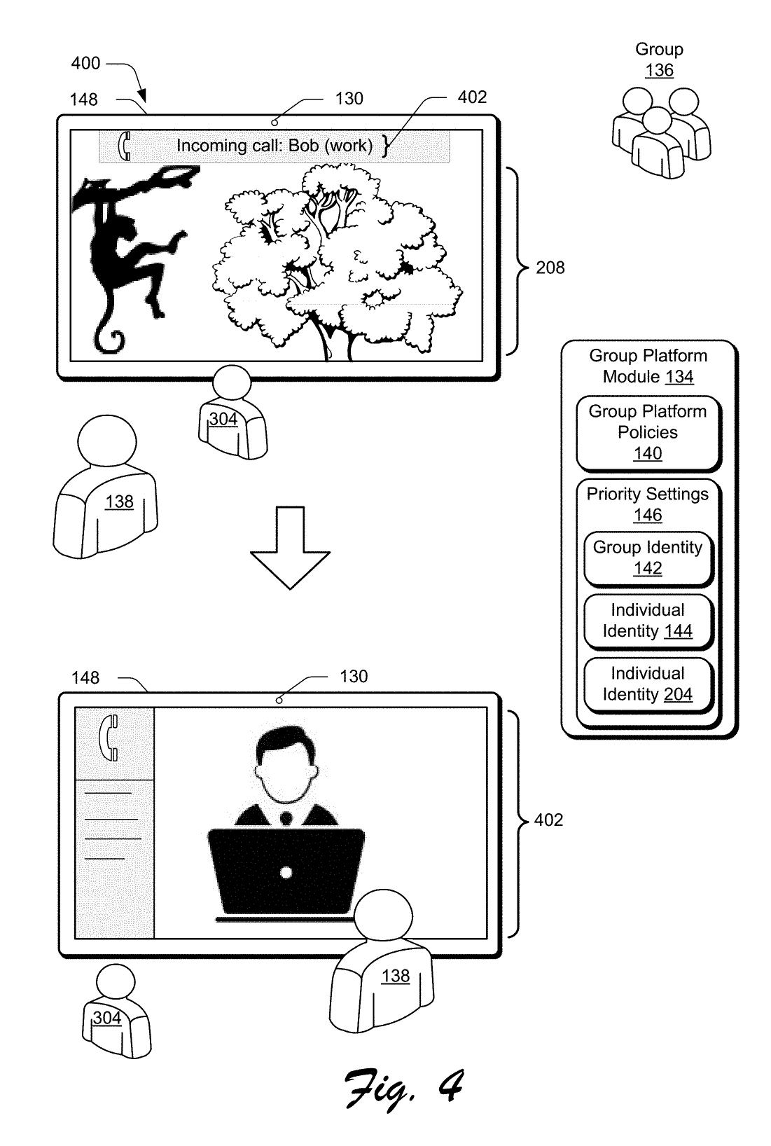

FIG. 4 depicts an example implementation scenario 400 for presenting content optimized for priority settings in accordance with one or more implementations. The scenario 400 includes various entities and components introduced above with reference to the environment 100. The scenario 400, for instance, may be implemented in conjunction with the scenarios 200 and 300 described above.

In the scenario 400, the user 138 (Alice) and the child user 304 (Cathy) are both users from the group 136 associated with the group identity 142. In this particular scenario, the group platform module 134 presents optimized content 208 to Cathy on the GUI 148 while Alice is in the same vicinity (e.g., room). Further to this scenario, the group platform module 134 receives content 402 associated with Alice. The content 402, for instance, represents an incoming call to Alice. Accordingly, the presence sensors 130 detect that Alice is in the vicinity of the GUI 148. Example ways in which presence is detected are detailed above. As a result, the group platform module 134 determines the priority settings 146 for presenting the content 208 and 402 based on the group identity 142 and an individual identity 144 and 204 associated with Alice and Cathy, respectively.

As shown in this example, the content 402 is presented by the group platform module 134 as a notification on the GUI 148. In some implementations, whether to present the content 402, how much of the content 402 to present, and/or whether verification of an identity is required are determined by the group platform module 134 according to the group platform policies 140 and the priority settings 146. Thus, presentation of the content 402 is determined by the group platform module 134 according to presence of users from the group 136.

In some implementations, when the group platform module 134 causes presentation of a notification, an option to expand the notification to see further content is available. Consider, for instance, that Cathy receives a text message from a friend and Alice is detected in the room by the presence sensors 130. In this instance, assume that the priority settings 146 specify that text messages received for Cathy on the GUI 148 are to be presented in a collapsed form to protect the privacy of the text messages when another individual (in this case, Alice) is detected to be in the vicinity of the GUI 148. As a result, the text message is presented in collapsed form on the GUI 148, thus not presenting the content of the text message in the presence of Alice based on the priority settings 146.

Continuing with the scenario 400, the group platform module 134 determines that the content 402 (the incoming call associated with Alice) receives priority over the optimized content 208 based on the priority settings 146. Responsive to determining priority of the content 402, the group platform module 134 causes presentation of the content 402 on the GUI 148 to enable Alice to interact with the incoming call. In some implementations, the group platform module 134 may enable separate and simultaneous presentation of content in the same GUI to multiple users from the group 136. The size, amount, and location of content may be modified by the group platform module 134 for output to the GUI 148 in a group-aware manner. For example, content 402 may be presented in a location of the GUI 148 nearest to Alice while the content 208 remains on the GUI 148 in a smaller size and a location closer to Cathy.

Consider now an instance where the group platform module 134 determines that Alice is not present in the vicinity of the GUI 148 (via the presence sensors 130), the group platform module 134 would then not cause the incoming call to be presented on the GUI 148 and would instead continue to present the content 208 to Cathy on the GUI 148.

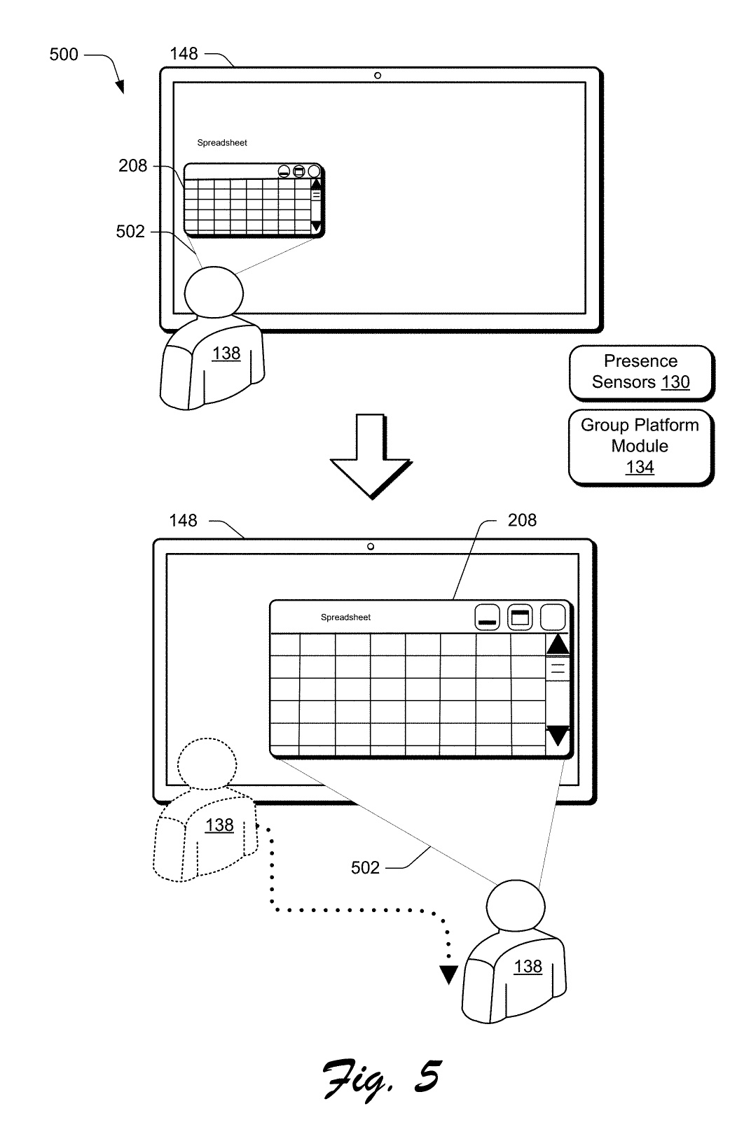

FIG. 5 depicts an example implementation scenario 500 for presenting content optimized for priority settings in accordance with one or more implementations. The scenario 500 includes various entities and components introduced above with reference to the environment 100. The scenario 500, for instance, may be implemented in conjunction with the scenarios 200, 300, 400 described above.

In the scenario 500, the client device 102 is configured to include proximity sensing via the presence sensors 130. While proximity sensing is depicted in the scenario 500, it is to be appreciated that any user detection technique may be contemplated in implementations, such as those described above.

The group platform module 134 configures the GUI 148 to enter an interaction state that is characterized by presenting the optimized content 208 at a particular size, shape, and/or location on the GUI 148 such that, when presented, the optimized content 208 is configured to engage the user 138. In at least this way, the GUI 148 can represent a glance-able viewing experience 502. While a single user is depicted, it is to be appreciated that the content 208 may be presented to engage more than one user from the group 136 (for instance, Alice, Bob, and Cathy).

Continuing with this scenario, in response to the presence sensors 130 detecting movement by the user 138, the group platform module 134 causes the size and location of the optimized content 208 to be altered to account for the detected movement (illustrated by the dotted line). Generally, the group platform module 134 causes the optimized content 208 to be altered based on contextual information. In some implementations, the group platform module 134 causes the optimized content 208 to be altered based on the direction, angle, or speed of movement by the user 138 in relation to the GUI 148. Whereas in additional or alternative implementations, the group platform module 134 causes the optimized content 208 to be altered based on a change in body position or angle of the user 138 in relation to the GUI 148.

When the contextual information indicates that the user 138 is not able to see the GUI 148, the group platform module 134 may configure the GUI 148 to present sound output instead of displaying the optimized content 208 visually. The same is true for situations in which the user 138 interacts from farther away. Depending on the distance, the group platform module 134 may operate to switch to sound, use sound and/or adapt the GUI 148 by changing font size, graphics, colors, level of detail, contrasts and other aspects of the optimized content 208. When the user 138 is further away from the system, the system may also adjust the volume of sound output or a clarity of synthesized speech output by increasing the overall pitch. As the user 138 approaches the GUI 148, indications such as icons, animations, and/or audible alerts may be output to signal that different types of interaction are active and also indications may be output to indicate when the identity of the user 138 has been recognized (e.g., an alert sound and user icon).

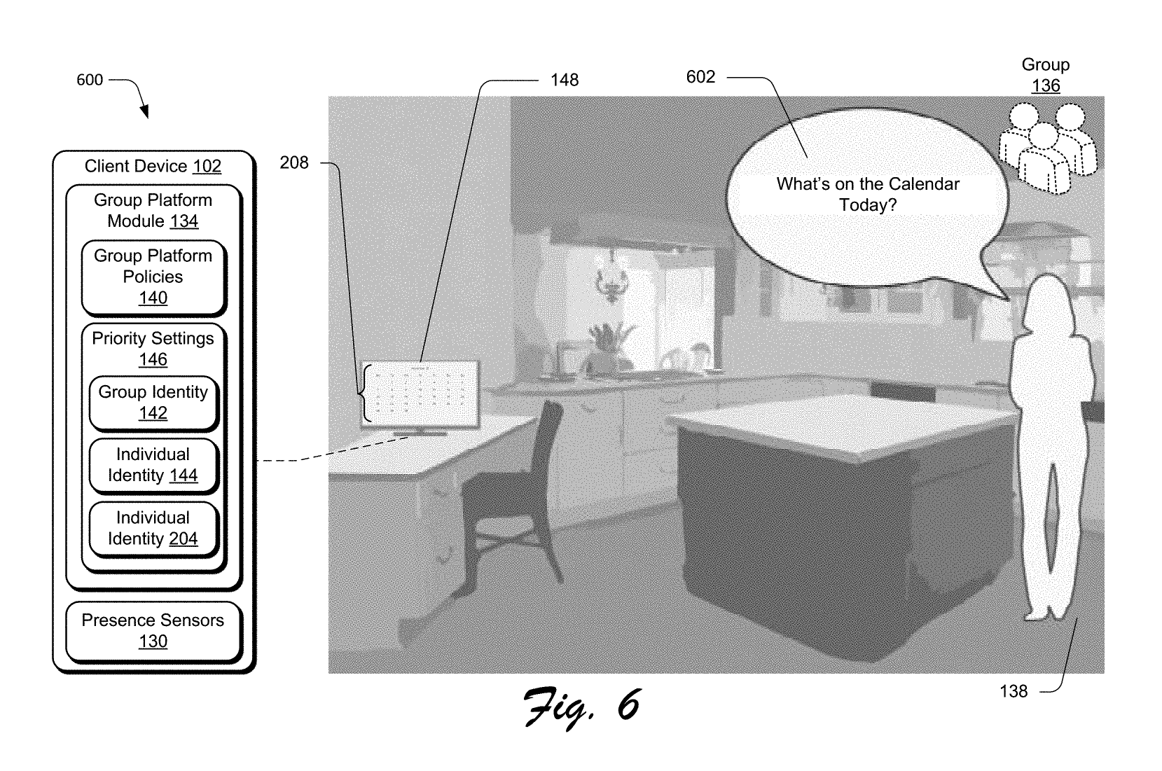

FIG. 6 depicts an example implementation scenario 600 for group interactions in accordance with one or more implementations. The scenario 600 includes the user 138 in the vicinity of the client device 102 having the group platform module 134. As shown, the GUI 148 is presented to the user 138 for group interactions and represents a single physical location for interacting. In this instance, the user 138 represents a single user that interacts with the group platform module 134. While a single user is depicted, it is to be appreciated that multiple users may interact with the GUI 148, for instance, Alice, Bob, and Cathy.

In the scenario 600, the GUI 148 is configured by the group platform module 134 to include voice activation and recognition functionality, proximity sensing, and/or other user detection techniques. In this way, the client device 102 can “awaken” in a centrally located environment to respond to voice tasks related to interactions with the GUI 148. Based on data received from the presence sensors 130, the group platform module 134 may adjust a display brightness of the GUI 148. The GUI 148 can provide group-related content 208 independent of authorization and without verifying the identity of the nearby user 138. Additionally or alternatively, the GUI 148 can recognize the nearby user 138 and verify their identity before displaying all or certain portions of the content 208.

According to various implementations, the group platform module 134 can cause the GUI 148 to automatically present a welcome screen after a time-out period and/or engaging the nearby user 138. For example, the presence sensors 130 can be used by the group platform module 134 to invoke passive detection techniques. In some implementations, the group platform module 134 can cause the GUI 148 to automatically present a welcome screen or specific content associated with the group identity 142 based on a time of day or other learned behavior of the group 136 or individual user from the group 136. For instance, the user 138 always leaves for work at 7:30 AM and responsive to the establishment of a predictable pattern, the group platform module 134 presents a traffic reminder at 7:30 AM each day on the GUI 148.

Consider now an instance where the group platform module 134 determines whether to present the optimized content 208 responsive to a voice command 602 based on the priority settings 146 for the user 138 and any other users who are detected to be in the vicinity of the GUI 148 by the presence sensors 130. In this instance, the group platform module 134 causes the content 208 presented to be group-aware by modifying the content for presentation in accordance with the group identity 142. Generally, the modifying can include altering, replacing, updating, including, excluding, and/or exchanging data for presentation to meet the collective needs of each group member. As an example, the user 138 (Alice) and the child user 304 from FIG. 3 (Cathy) are both present in a room when Alice gives a voice command to play music, and responsive to detecting the presence of Cathy the group platform module 134 causes music to be played that does not contain explicit content based on the priority settings 146 and group platform policies 140. As an additional example, the group platform module 134 determines to adapt the optimized content 208 presented due to a disability of the user 138, as indicated by the group platform policies 140 and the priority settings 146.

In response to the group platform policies 140 and priority settings 146, the group platform module 134 is configured to adapt voice settings in terms of language, pitch, vocabulary, switching language models, and changing visual content.

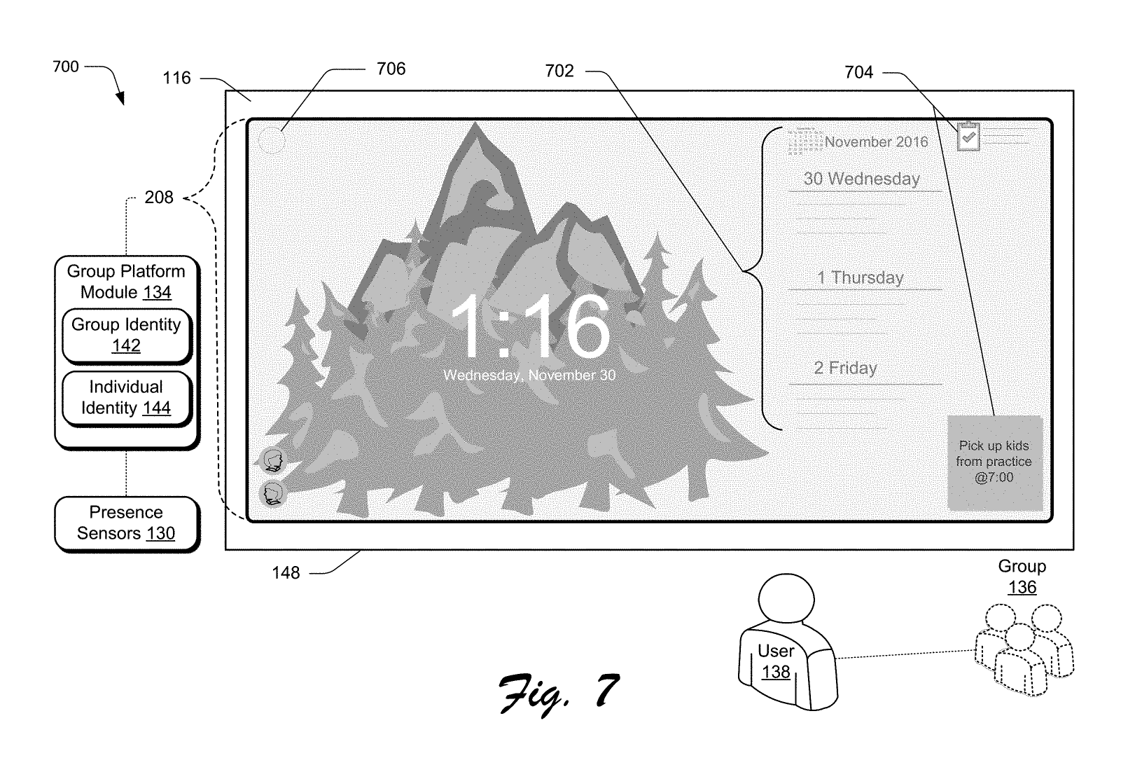

FIG. 7 depicts an example implementation scenario 700 for a shared desktop in accordance with one or more implementations. The scenario 700 includes the GUI 148 presented on the display device 116 as a shared desktop by the group platform module 134.

As depicted in the scenario 700, the shared desktop is generally representative of the GUI 148 configured with the optimized content 208 that is group-aware. In this scenario, the GUI 148 depicts a group calendar 702, notes and reminders 704, and voice service 706. According to various implementations, the voice service 706 may be implemented as the digital assistant 132 and may support interaction with the calendar 702 and any other content presented in or available for interaction through the GUI 148 to provide simple and immediate input capabilities to the user 138.

Generally, the GUI 148 can enable presentation of various kinds of information associated with the group identity 142 or the individual identity 144 including but not limited to: schedules, reminders, lists, notifications, media (e.g., photos, video, music, and so on), weather, and settings. In some implementations, the GUI 148 can appear on the output devices 114 (e.g., the display device 116) responsive to creation of the group identity 142 by the group platform module 134 and/or can act as a default location for individuals accessing the shared desktop.

As depicted in this scenario, the GUI 148 can be configured to represent a “welcome screen” that provides functionality to support sharing of information among one or more different individuals of the group 136. Accordingly, the GUI 148 can appear on a shared desktop provided by the group platform module 134. In some implementations, the GUI 148 is available for interaction with an additional identity that is not associated with the group identity 142, provided the group platform module 134 grants access to the additional identity. In another implementation, this can include granting access to a guest and not using the group identity 142 for interactions with the GUI 148.

Generally, interaction with the GUI 148 does not require express user input and instead can be initiated through sensors on a computing device, such as the presence sensors 130. For instance, once included in the group 136 as part of the initial set-up of a shared desktop, subsequent visits to the GUI 148 are automatically authorized by the group platform module 134. In some implementations, interaction with the GUI 148 requires express input according to the group platform policies 140. For instance, the group platform policies 140 specify that when a guest is detected by the presence sensors 130, the GUI 148 is not presented without express input. Additionally and alternatively, the group platform policies 140 may specify whether or not the GUI 148 is presented based on a physical location of the GUI 148, the client device 102, or a device on which the GUI 148 is available.

Thus, these example scenarios demonstrate that techniques for presenting content associated with a group identity enable group interaction in a single, physical location.

Having discussed some example implementation scenarios, consider now a discussion of some example procedures in accordance with one or more embodiments.

The following discussion describes some example procedures for group interactions in accordance with one or more embodiments. The example procedures may be employed in the environment 100 of FIG. 1, the system 1100 of FIG. 11, and/or any other suitable environment. The procedures, for instance, represent example procedures for implementing the scenarios described above. In at least some implementations, the steps described for the various procedures are implemented automatically and independent of user interaction. According to various implementations, the procedures may be performed locally (e.g., at the client device 102) and/or at a network-based service, such as the group service 150.

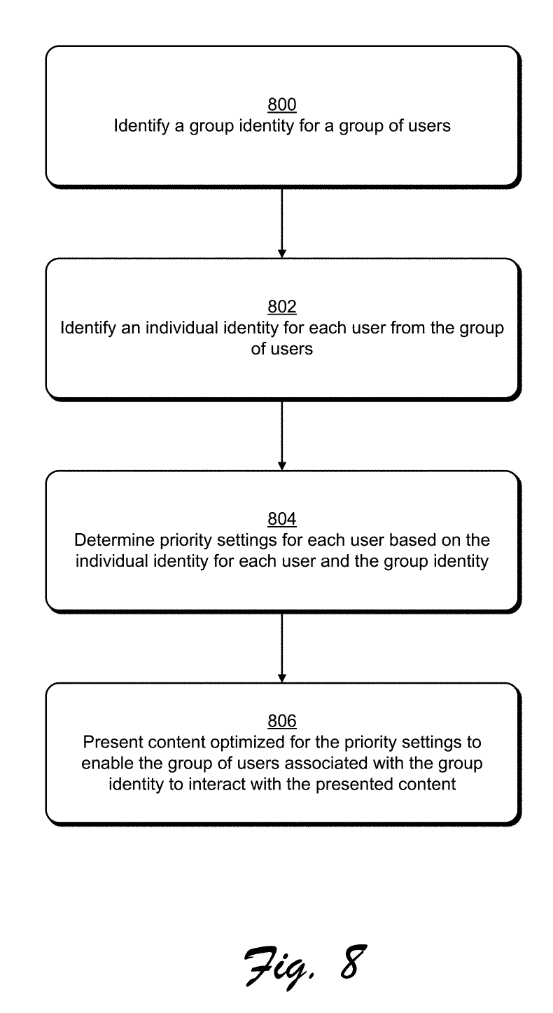

FIG. 8 is a flow diagram that describes steps in a method in accordance with one or more implementations. The method describes an example procedure for presenting content for a group in accordance with one or more implementations. In at least some implementations, the method may be performed at least in part at the client device 102 (e.g., by the group platform module 134) and/or by the group service 150.

Step 800 identifies a group identity for a group of users. The group platform module 134, for instance, communicates with the group service 150 over the network 104 to obtain the group identity 142 for the group 136. Example ways of identifying the group identity 142 are discussed above.

Step 802 identifies an individual identity for each user from the group of users. In some implementations, the individual identity 144 for each user from the group 136 is obtained from the individual service 152 over the network 104. Example ways of identifying the individual identity 144 are described above.

Step 804 determines priority settings for each user based on the individual identity for each user and the group identity. Generally, the group platform module 134 determines the priority settings 146 in accordance with the group platform policies 140 implemented by the group platform module 134. For instance, the priority settings 146 are determined for each user from the group 136 relative to each other based on the individual identity 144 of each user and the group identity 142. Different ways of determining the priority settings 146 are described above.

Step 806 presents content optimized for the priority settings to enable the group of users associated with the group identity to interact with the presented content. For example, the group platform module 134 causes the content 208 to be presented on the GUI 148 of the client device 102, the content 208 optimized for the presence of one or more users associated with the group identity 142. Generally, this permits the one or more users associated with the group identity 142 to interact with the presented content 208 through the GUI 148 optimized for group interactions.

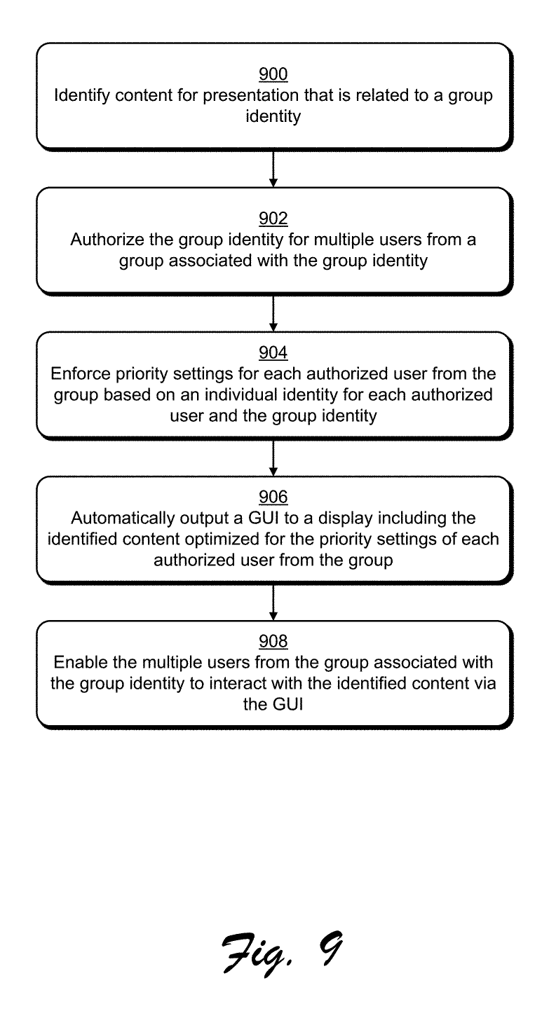

FIG. 9 is a flow diagram that describes steps in a method in accordance with one or more implementations. The method describes an example procedure for presenting content for a group in accordance with one or more implementations. In at least some implementations, the method may be performed at least in part at the client device 102 (e.g., by the group platform module 134) and/or by the group service 150.

Step 900 identifies content for presentation that is related to a group identity. Generally, content 206 related to the group identity 142 is identified and received by the group platform module 134. Example ways of identifying content 206 for presentation are discussed above.

Step 902 authorizes the group identity for multiple users from a group associated with the group identity. For example, a device ticket is communicated from the group service 150 or the operating system 106 to the group platform module 134. Additionally or alternatively, input from the presence sensors 130 is utilized to authorize users. The group platform module 134 may, for instance, authorize the group identity 142 upon initial setup of a shared device. Example ways of authorizing the group identity 142 are described above.

Step 904 enforces priority settings for each authorized user from the group based on an individual identity for each authorized user and the group identity. Generally, the group platform module 134 enforces the priority settings 146 in accordance with the group platform policies 140. The group platform policies 140, for instance, specify which content to present and how to configure content 206 for display based on factors associated with priority, identity, presence, and so forth. In some implementations, the priority settings 146 may be content and/or application-specific. Different ways of enforcing the priority settings 146 are described above.

Step 906 automatically outputs a GUI to a display including the identified content optimized for the priority settings of each authorized user from the group. The group platform module 134 may cause the content 208 to be presented on the GUI 148 of the client device 102 optimized for presence and/or proximity of users associated with the group identity 142. Generally, this permits users from the group 136 associated with the group identity 142 to interact with the presented content 208 through the GUI 148 optimized for group interactions.

Step 908 enables the multiple users from the group associated with the group identity to interact with the identified content via the GUI. For example, the group platform module 134 causes the GUI 148 to be automatically output to enable one or more users from the group 136 to interact with the identified content 208 in a single physical location. Different ways of enabling users from a group to interact with content are described above.

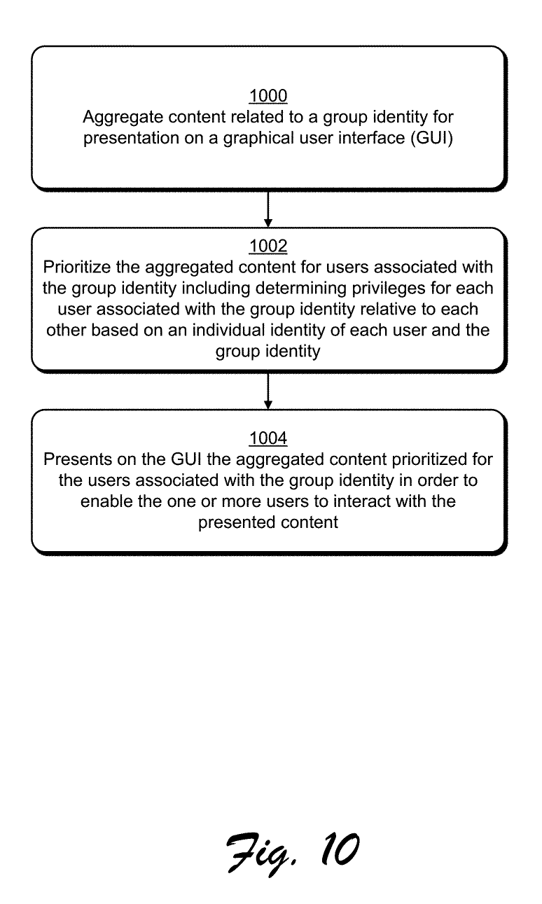

FIG. 10 is a flow diagram that describes steps in a method in accordance with one or more implementations. The method describes an example procedure for presenting content for a group in accordance with one or more implementations. In at least some implementations, the method may be performed at least in part at the client device 102 (e.g., by the group platform module 134) and/or by the group service 150.

Step 1000 aggregates content related to a group identity for presentation on a graphical user interface (GUI). The group platform module 134, for instance, aggregates the content 206 associated with the group identity 142. The content 206 may be received over the network 104. Example ways of aggregating content for presentation are discussed above.

Step 1002 prioritizes the aggregated content for users associated with the group identity including determining privileges for each user associated with the group identity relative to each other based on an individual identity of each user and the group identity. The group platform module 134, for instance, determines privileges for each user from the group 136 relative to each other based on the priority settings 146 and the group platform policies 140. The priority settings 146 are determined based on the individual identity 144 of each user from the group 136 and the group identity 142. Additionally, the priority settings 146 are enforced in accordance with the group platform policies 140.

Step 1004 presents on the GUI the aggregated content prioritized for the users associated with the group identity in order to enable the one or more users to interact with the presented content. Generally, this permits one or more users from the group 136 associated with the group identity 142 to interact with the presented content 208 through an interface optimized for group interactions. Different ways of enabling users from the group 136 to interact with content 208 are described above.

Having discussed some example procedures, consider now a discussion of an example system and device in accordance with one or more embodiments.

FIG. 11 illustrates an example system generally at 1100 that includes an example computing device 1102 that is representative of one or more computing systems and/or devices that may implement various techniques described herein. For example, the client device 102 discussed above with reference to FIG. 1 can be embodied as the computing device 1102. The computing device 1102 may be, for example, a server of a service provider, a device associated with the client (e.g., a client device), an on-chip system, and/or any other suitable computing device or computing system.

The example computing device 1102 as illustrated includes a processing system 1104, one or more computer-readable media 1106, and one or more Input/Output (I/O) Interfaces 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1106 is illustrated as including memory/storage 1112. The memory/storage 1112 represents memory/storage capacity associated with one or more computer-readable media. The memory/storage 1112 may include volatile media (such as random access memory (RAM)) and/or nonvolatile media (such as read only memory (ROM), Flash memory, optical disks, magnetic disks, and so forth). The memory/storage 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1110 and computer-readable media 1106 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of modules that are executable by the computing device 1102 as software may be achieved at least partially in hardware, e.g., through use of computer-readable storage media and/or hardware elements 1110 of the processing system. The instructions and/or functions may be executable/operable by one or more articles of manufacture (for example, one or more computing devices 1102 and/or processing systems 1104) to implement techniques, modules, and examples described herein.

As further illustrated in FIG. 11, the example system 1100 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1100, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1102 may assume a variety of different configurations, such as for computer 1114, mobile 1116, and television 1118 uses. Each of these configurations includes devices that may have generally different constructs and capabilities, and thus the computing device 1102 may be configured according to one or more of the different device classes. For instance, the computing device 1102 may be implemented as the computer 1114 class of a device that includes a personal computer, desktop computer, a multi-screen computer, laptop computer, netbook, and so on.

The computing device 1102 may also be implemented as the mobile 1116 class of device that includes mobile devices, such as a mobile phone, portable music player, portable gaming device, a tablet computer, a wearable device, a multi-screen computer, and so on. The computing device 1102 may also be implemented as the television 1118 class of device that includes devices having or connected to generally larger screens in casual viewing environments. These devices include televisions, set-top boxes, gaming consoles, and so on.

The techniques described herein may be supported by these various configurations of the computing device 1102 and are not limited to the specific examples of the techniques described herein. For example, functionalities discussed with reference to the group platform module 134, the group service 150, and/or the individual service 152 may be implemented all or in part through use of a distributed system, such as over a “cloud” 1120 via a platform 1122 as described below.

The cloud 1120 includes and/or is representative of a platform 1122 for resources 1124. The platform 1122 abstracts underlying functionality of hardware (e.g., servers) and software resources of the cloud 1120. The resources 1124 may include applications and/or data that can be utilized while computer processing is executed on servers that are remote from the computing device 1102. Resources 1124 can also include services provided over the Internet and/or through a subscriber network, such as a cellular or Wi-Fi network.

The platform 1122 may abstract resources and functions to connect the computing device 1102 with other computing devices. The platform 1122 may also serve to abstract scaling of resources to provide a corresponding level of scale to encountered demand for the resources 1124 that are implemented via the platform 1122. Accordingly, in an interconnected device embodiment, implementation of functionality described herein may be distributed throughout the system 1100. For example, the functionality may be implemented in part on the computing device 1102 as well as via the platform 1122 that abstracts the functionality of the cloud 1120.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 1100.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A system for presenting content for group interactions, the system comprising: at least one processor; and one or more computer-readable storage media including instructions stored thereon that, responsive to execution by the at least one processor, cause the system to perform operations including: identifying a group identity for a group of users; identifying an individual identity for one or more users from the group of users; determining priority settings for the one or more users based on the individual identity for the one or more users and the group identity; and presenting content via a client device optimized for the priority settings to enable the group of users associated with the group identity to interact with the presented content.

In addition to any of the above described systems, any one or combination of: wherein the group identity is created by one or more of an operating system of the client device, or via a different device; wherein the individual identity is created by one or more of an operating system of the client device, or via a different device; wherein the group identity is created at one or more of initial setup of the client device, or after the initial setup; wherein the one or more users associated with the group identity are authorized to interact with the presented content on the client device without providing express user input to authenticate the one or more users; wherein the operations further include initiating by one or more users an interaction with the presented content through one or more sensors configured to detect user input; wherein said presenting the content via the client device occurs responsive to one or more sensors detecting a user presence such that the client device awakens; wherein said presenting the content comprises presenting the content optimized for a user including one or more of presence, proximity, time of day, or a signal from one or more of a different device or a service; wherein said presenting the content comprises configuring a size, shape, and/or location of the content to enable the one or more users from the group to view the content at a glance; and wherein said identifying occurs responsive to a voice command received from a user from the group.

A computer-implemented method for presenting content for group interactions, the method comprising: identifying content for presentation that is related to a group identity; authorizing the group identity for multiple users from a group associated with the group identity; enforcing priority settings for each authorized user from the group based on an individual identity for each authorized user and the group identity; automatically outputting a graphical user interface (GUI) to a display including the identified content optimized for the priority settings of each authorized user from the group; and enabling the multiple users from the group associated with the group identity to interact with the identified content via the GUI.

In addition to any of the above described methods, any one or combination of: wherein said identifying occurs responsive to a voice command received from a user from the group; wherein the GUI is configured as a welcome screen supporting content associated with the individual identity of one or more users from the group and the group identity; wherein the GUI includes content associated with the group identity including one or more of a calendar, notes, reminders, media, settings, notifications, or other content selected by a user associated with the group identity; wherein said outputting comprises configuring a size, shape, and/or location of the content on the display to enable one or more users from the group to view the content at a glance; further comprising detecting the presence of one or more users from the group in the vicinity of the display and said configuring comprises one or more of: configuring the size, shape, and/or location of the content on the display according to the location of the one or more users relative to the display; or configuring speech output according to the location of the one or more users; wherein said authorizing comprises obtaining the group identity from a local operating system; and wherein the individual identity of each authorized user from the group is obtained from a local operating system.

A computer-implemented method for presenting content for group interactions, the method comprising: aggregating content related to a group identity for presentation on a graphical user interface (GUI); prioritizing the aggregated content for users associated with the group identity including determining privileges for each user associated with the group identity relative to each other based on an individual identity of each user and the group identity; and presenting on the GUI the aggregated content prioritized for the users associated with the group identity in order to enable the one or more users to interact with the presented content.

In addition to any of the above described methods, any one or combination of: further comprising detecting the presence and/or identity of the one or more users through input from one or more sensors; further comprising assigning the group identity to represent a group of individual identities; wherein the group identity was assigned during initial setup of a shared device; wherein the GUI is configured as a welcome screen supporting content associated with the individual identity of one or more users from the group and the group identity; and wherein the GUI includes content associated with the group identity including one or more of a calendar, notes, reminders, media, settings, notifications, or other content selected by a user associated with the group identity.

Techniques for group interaction are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
at least one processor; and
one or more computer-readable storage media including instructions stored thereon that, responsive to execution by the at least one processor, cause the system to perform operations including:
identifying a group identity for a group of users;
identifying an individual identity for one or more users from the group of users;
determining priority settings for the one or more users based on the individual identity for the one or more users and the group identity; and
presenting content via a client device optimized for the priority settings to enable the group of users associated with the group identity to interact with the presented content.

2. A system as described in claim 1, wherein the group identity is created by one or more of an operating system of the client device, or via a different device.

3. A system as described in claim 1, wherein the individual identity is created by one or more of an operating system of the client device, or via a different device.

4. A system as described in claim 1, wherein the group identity is created at one or more of initial setup of the client device, or after the initial setup.

5. A system as described in claim 1, wherein the one or more users associated with the group identity are authorized to interact with the presented content on the client device without providing express user input to authenticate the one or more users.

6. A system as described in claim 1, wherein the operations further include initiating by one or more users an interaction with the presented content through one or more sensors configured to detect user input.

7. A system as described in claim 1, wherein said presenting the content via the client device occurs responsive to one or more sensors detecting a user presence such that the client device awakens.

8. A system as described in claim 1, wherein said presenting the content comprises presenting the content optimized for a user including one or more of presence, proximity, time of day, or a signal from one or more of a different device or a service.

9. A computer-implemented method, comprising:
identifying content for presentation that is related to a group identity;
authorizing the group identity for multiple users from a group associated with the group identity;
enforcing priority settings for each authorized user from the group based on an individual identity for each authorized user and the group identity;
automatically outputting a graphical user interface (GUI) to a display including the identified content optimized for the priority settings of each authorized user from the group; and
enabling the multiple users from the group associated with the group identity to interact with the identified content via the GUI.

10. A method as described in claim 9, wherein said identifying occurs responsive to a voice command received from a user from the group.

11. A method as described in claim 9, wherein the GUI is configured as a welcome screen supporting content associated with the individual identity of one or more users from the group and the group identity.

12. A method as described in claim 9, wherein the GUI includes content associated with the group identity including one or more of a calendar, notes, reminders, media, settings, notifications, or other content selected by a user associated with the group identity.

13. A method as described in claim 9, wherein said outputting comprises configuring a size, shape, and/or location of the content on the display to enable one or more users from the group to view the content at a glance.

14. A method as describe in claim 9, further comprising detecting the presence of one or more users from the group in the vicinity of the display and said configuring comprises one or more of:
configuring the size, shape, and/or location of the content on the display according to the location of the one or more users relative to the display; or
configuring speech output according to the location of the one or more users.

15. A method as described in claim 9, wherein said authorizing comprises obtaining the group identity from a local operating system.

16. A method as described in claim 9, wherein the individual identity of each authorized user from the group is obtained from a local operating system.

17. A computer-implemented method, comprising:
aggregating content related to a group identity for presentation on a graphical user interface (GUI);
prioritizing the aggregated content for users associated with the group identity including determining privileges for each user associated with the group identity relative to each other based on an individual identity of each user and the group identity; and
presenting on the GUI the aggregated content prioritized for the users associated with the group identity in order to enable the one or more users to interact with the presented content.

18. A method as described in claim 17, further comprising detecting the presence and/or identity of the one or more users through input from one or more sensors.

19. A method as described in claim 17, further comprising assigning the group identity to represent a group of individual identities.

20. A method as described in claim 17, wherein the group identity was assigned during initial setup of a shared device.
